(19) United States
(12) Patent Application Publication
(10) Pub. No.: US 2014/0379562 A1
(43) Pub. Date: Dec. 25, 2014

(54) INTERMEDIARY PAYMENT AND ESCROW SYSTEM AND METHOD

(71) Applicant: UniCache International Ltd., Las Vegas, NV (US)

(72) Inventors: Arthur Wayne Olson, Las Vegas, NV (US); Gunther E. Gossmann, Acworth, GA (US); Renata A. Kloepfer, Las Vegas, NV (US)

(21) Appl. No.: 14/309,013

(22) Filed: Jun. 19, 2014

Related U.S. Application Data
(60) Provisional application No. 61/836,973, filed on Jun. 19, 2013.

(51) Int. Cl. G06Q 20/02

(52) U.S. Cl. CPC G06Q 20/027
USPC 705/39

(57) ABSTRACT

A method for enabling consumers in a commercial or gaming context to push funds from a traditional open loop account to a closed loop account, and back. At the request of a consumer, funds are transferred to an open loop account of an intermediary payment system that holds or keeps track of virtual closed loop accounts for each consumer and virtual open or closed loop accounts for individual electing merchants or gaming establishments. The consumer may elect to open and use an associated closed loop card to acquire goods or services at the electing private label merchant's or to place a bet at the private label gaming facility or device that will cause funds to be transferred from the consumer's virtual closed loop account to the merchant or gaming establishment's closed loop account. Thereafter, the funds are transferred from the intermediary payment system to an open loop account belonging to the commercial or gaming merchant. The system allows for many unique functionalities so that the consumer does not need a bank account, but can through card features selected, use one or more accounts like a bank account, including for international transactions, linking of cards (as an example for money transfers to students), and make purchases free of digital tracking to the account holding consumer. The method further benefits merchants and others involved in their use through the ability to structure non-traditional fee structures and loyalty or other rewards.

### CROSS-REFERENCE TO RELATED APPLICATIONS

This application claims the benefit of U.S. Provisional Application No. 61/836,973 filed Jun. 19, 2013, which is incorporated herein by reference in its entirety

### STATEMENT RE: FEDERALLY SPONSORED RESEARCH/DEVELOPMENT

Not Applicable

### FIELD OF THE INVENTION

The present invention is related to the financial services industry. More particularly, the present invention is related to broadening the use, flexibility and privacy of financial networks facilitating funds transfers between accounts in unrelated and respectively isolated financial systems.

### BACKGROUND

Consumers with bank accounts presently enjoy tremendous capability to purchase goods and services, i.e., conduct financial transactions, almost anywhere in the world. The US banking system, in particular, facilitates this activity, through conventional means such as wire-transfers, checks and funds-transfers through the automated clearing house network (ACH—operated by The Electronic Payments Association, NACHA), and through regional networks such as Mac and Star, or national and international networks such as Amex, Visa, MasterCard, and so on. Often, traditional bank accounts are connected to these various networks by an issuing bank, and the Consumer is given a card (debit or credit), which the account-holding Consumer presents at a point of sale, or simply enters the account number on the card into a web page for an online purchase. The purchase, then, initiates a transfer of funds from the card/account holder's bank account to the Merchant in exchange for goods and services. The issuing bank typically is the bank that holds the account, and also is a member of the network(s) indicated on the particular card. From the network provider's perspective (e.g., Visa), the bank that caused the card to be issued is the “issuing bank.”

Identifying which networks are connected to a given account can often be accomplished by looking at the reverse side of a card, where the logos of the various networks, often called “bugs,” are printed. These various networks, when they are not specific to a particular merchant or venue, are called “open-loop” in the payments industry. Discover, Star Amex, Visa and MasterCard are examples of networks which, when associated with a card and account make the card “open-loop.” Conversely, accounts and their corresponding cards which are not open, but instead only perform their function at a particular store or chain of stores, or at a specific venue, are called “closed-loop.” Examples of closed-loop cards might be those “Gift Cards” available at many retail establishments or cards issued by other retailers such as Nordstrom, Starbucks, or Old Navy. Those cards “work,” i.e., can be used to make a purchase, only within those stores. A Starbucks Gift Card will not work at a Nordstrom store, nor can it be used ‘at large’ to purchase gas, groceries, airline tickets, etc., as is true with open-loop cards such as Visa or MasterCard. It is noted that it is not necessarily a “card” that is open or closed-loop, but it is rather the nature of the account “behind” the card. As such, open and closed-loop account numbers can be just as easily associated with, e.g., cell phones, a key, other devices or a voucher.

The power and attraction of open-loop cards is universal application and accessibility for commerce.

The power and attraction of closed-loop cards is that the stores/venues keep the money in their stores—so that gift cards and outstanding balances are more likely to be spent in the store that issued the card. If an open-loop card were used in place of a closed-loop card in such a store, the card holder might just as well spend the money elsewhere or even use an ATM to receive cash and the store that issued the card would lose a sale. While they have this ability to ‘capture’ the Consumer's money, closed-loop cards do not typically offer the protection of open-loop cards such as government banking regulations (e.g., Regulation “E” disclosures), Visa's $0 liability for signature purchases, FDIC deposit insurance, and more. Closed-loop cards can also be more difficult to get money “in and out” of since the number of locations and variety of means afforded to do so are typically much more restrictive than accounts in the banking system.

It is also true that a large number of persons do not have bank accounts. Similar features can be made available to theses “un-bankable” consumers through the creation of sub-account of an intermediary which has a bank account and serves in that role with open and/or closed loop accounts and the issuance thereon of one or more cards (which, as appropriate, could be debit, credit, pre-paid, gift, stored value, payroll and/or private label cards). That this has wide applicability is evidenced by the fact that over 22 million U.S. households have no bank account at all, while another 20 million are estimated to be under banked, with limited financial relationships, making it difficult to participate in the U.S. economy.

The Intermediary sub-account issuer follows all the traditional rules to examine the applicant Consumer prior to sub-account issuance. These include the data base checks and banking regulation compliance relating to ‘knowing’ the customer.

Cards or sub-accounts with the independent BIN numbers under the Intermediary can then be used in the national and international financial processing networks without restrictions prohibiting, for example, cross border transactions, gaming and providing consumer privacy since transactions are tracked to the intermediary entity but not to the sub-account holder. This gives the Consumer the further advantages of choice in card criteria and linkages.

Being outside the bank and associations' traditional rules allow these Intermediary Payment system accounts to have rules spreading the fees charged for the account, card and/or their use, among those involved in the marketing and the card-holder's use thereof, again outside traditional rules. This allows the incentivization of differing marketing organizations and groups encouraging more creative commerce. For example, 60 million Americans receive paper paychecks; over 40% of this population has no bank account and for safety and convenience needs a direct deposit vehicle. Moreover, $500 billion in payroll checks are issued annually to unbanked employees. Forbes Magazine cited a recent study that shows companies can reduce their payroll costs by up to 40% when they switch from printed checks to electronic pay. An open loop payroll card issued by an intermediary using this invention would benefit these unbanked individual's, the employers and can be structured so that the intermediate provider or facilitating entity(ies) benefits through card use fee economic returns, presently unavailable in the market.

The problems to be solved by this invention are convenience, flexibility, privacy and economic incentives outside the traditional bank and card association structures, along with perception. The problem arises in the context of the gaming industry, but the solution is applicable well beyond this particular industry, as will be appreciated by those skilled in the art. In the past for example, the Las Vegas Gaming Commission briefly allowed gaming establishment operators (a “GEO”) to connect their machines to the banking networks so that players could use their bank cards to pay for slot machines (one example). This experiment did not last long, as it was quickly deemed unacceptable that such establishments could ‘reach’ into consumers' bank accounts directly. This has resulted in somewhat convoluted solutions, where (as a further example) a Consumer uses an ATM (very expensive, fee-wise, on-site of the GEO) to get cash from their debit or credit card and then physically walks around a corner (e.g., 20-30 feet) to hand the money or some type of receipt to a cashier to put the money into a form that can be used with the gaming machines at that same site (e.g., a closed-loop card). The solution just suggested is rather awkward, and also, often times, far more expensive than a typical ATM implementation.

The paragraph 0011 suggested awkward solution essentially connects the open-loop system of a Consumer's choice (their personal credit, debit, check, or cash instruments) with the GEO's close-loop system by using the Consumer himself as a “courier” between the two. An advantage of this approach is that the consumer is clearly in control of the transaction. The disadvantages include the requirement to physically perform the task, which can include both time and distance at inopportune moments, and additionally (often) the greater expense of doing so.

As if to emphasize the matter of sensitivity towards public perception and possible negative associations with market branding and image, MasterCard, Visa and other financial transaction service providers have varying restrictions on the venues and types of merchants their cards are allowed to be used with. Gaming, for example, is explicitly excluded.

### SUMMARY OF THE INVENTION

The system and process described herein provides a complete solution outside a normal bank account, if desired, via the Intermediary and automates movement of funds between open and closed systems while still requiring the Consumer to explicitly initiate the transfer and comply with all banking regulations. To simplify the process, the Consumer has one or more sub-accounts with the Intermediary in the Intermediaries' bank account which is given access via all standard communications means to accomplish the movement of funds into and out of his/her Intermediary open or closed-loop sub-account from his/her open-loop account.

In an exemplary embodiment, there is provided:

a). An open-loop system, providing the Consumer a sub account of an Intermediaries' FDIC insured bank account and connected to, an international network, like MasterCard or Visa, and usable almost anywhere but using different BIN number sequences so as to be more flexible;

b). A closed-loop system, which can support issuance of various devices for the Consumer to employ, such as tokens, vouchers, electronics ID, or even cell phones (but for the purposes of this description will be a card similar in appearance to any debit card) and also using different BIN number sequences to provide flexibility not allowed via other networks;

c). A merchant-processing system which performs the same functions as in open-loop systems, allowing the merchant (in this example, a GEO or device) to pull funds (make a purchase) from the closed-loop card. This system interacts with the closed-loop system to accomplish the transaction—and does so using the same techniques, hardware, and protocols as any open-loop system would, however with different BIN number sequences, hence outside the traditional bank or association constraints, yet still complying with all Federal rules and regulations; and

d). An interface between the open and closed systems that allows for the real-time adjustment of balances and transfer of funds facilitating both external commerce of any type and the account maintenance for the Intermediary Entity's account bearing all account-holders sub-accounts.

The intermediary interface acts as a proxy, or escrow, for balances carried on the Intermediary Entity's open or closed system accounts. As funds are moved into the closed account at a user's request, and reflected in their corresponding account balances (sometimes referred to as virtual accounts or sub-accounts), the actual funds on the open-loop system can be moved from the Consumer's account there to a settlement account at the interface—providing safe escrow for the merchants (shops, GEOs, etc.) in that the funds are “good funds,” meaning in-hand, and available for instant transfer to the merchant's open/closed accounts as purchases are made. Using this means of holding funds available for gaming, the merchant or game is not at risk of having the funds withdrawn during the course of a game—without their knowledge. Also beneficial is that the funds continue to reside in a bona-fide bank account at all times, continuously insured and regulated by the nation's banking system, a benefit especially for one without a traditional bank account, providing safety from theft and the ability to transfer funds for the card/sub-account holder's needs at a lower cost.

To use the system, the consumer would obtain an ‘open-loop’ account (and card) which could be, e.g., MasterCard branded, or possibly just ATM and point-of-sale-capable and connected to a real bank account belonging either to the electing-Consumer directly, or through an intermediary via a sub-account of such intermediary. The account-holding Consumer would then have the ability to get money into and out of this account as with any checking or savings account (direct-deposit/ACH, over the counter, mail-in, and more). This could be done by conventional paper application, online, or even on-site.

The electing Consumer would also obtain a ‘closed-loop’ card (or other account number designator, including, for example, a cell phone telephone or account number). Again, the terms “open-loop” and “closed-loop” refer to whether a given account or card is ‘open’ to the financial and settlement community (stores, banks, ATMs), or is “closed” and only operates within a select network of systems and accounts; and in the context of the instant invention, are also are directly connected to the intermediate system or interface.

Using a cell phone and the interface's IVR (Interactive Voice Response), or other secure communication methods, an account-holding Customer can initiate movement of funds between his/her open and closed system accounts. Once the closed-loop card is funded, transactions are accomplished in the usual manner, as appropriate, to purchase goods and services on-site at a GEO.

What makes the system unique is that the open and closed systems can communicate with each other, are outside the traditional rules which apply to an association cards, e.g. Visa, and track to the intermediary payment account, rather than directly to the consumer sub-account holder, providing privacy, greater flexibility, and, at the account holding consumer's initiative, funds can be transferred from the open system to the closed system. It is a “push” style transaction, completely within the Consumer's control, and not a “pull” by the Merchant—which avoids the perception problem mentioned previously above.

Since the close-loop card is not branded with a bank, MasterCard, or some other transactional network provider's marks, there are no conflicts between use of the close-loop card and any of the banking or transactional network operating rules and regulations—or with governmental agencies by way of conflict with regulations concerning the use of the traditional bank or association issued open-loop card.

In addition, IVR support means that an electing account-holding consumer can accomplish funds transfers quickly and easily without having to go anywhere—or leave the site (especially when the Consumer uses a cell phone).

Finally, the electing account-holding Consumer can push any available closed-loop funds back to his/her open-loop account at any time, to make them available for use at stores, ATMs, or withdrawals at a financial institution.

The proposed solution keeps funds movement in and out of the open-loop system and bank accounts buffered/separated from those environments deemed inappropriate by the payments industry, and completely in the explicit control of the account-holder.

These and other features of the present invention, along with their attendant advantages are described below in association with several drawing figures.

### BRIEF DESCRIPTION OF THE DRAWINGS

FIG. 1 depicts a general view of the major components of the unique intermediary or escrow-like accounts and their establishment in accordance with an embodiment of the present invention.

FIG. 2 depicts a general view of A) the context of the major components of the full functionality of a system in relation to the global banking system; and B) individual account functioning, in accordance with an embodiment of the present invention.

FIG. 3 is a table that shows, sequentially, a relatively simple series of open and closed account balances for a single user/Consumer and a single merchant in accordance with the present invention.

FIG. 4 is a table that shows, sequentially, a more detailed series of open and closed account balances for two users/Consumers and, e.g., a single casino game in accordance with the present invention.

### DETAILED DESCRIPTION

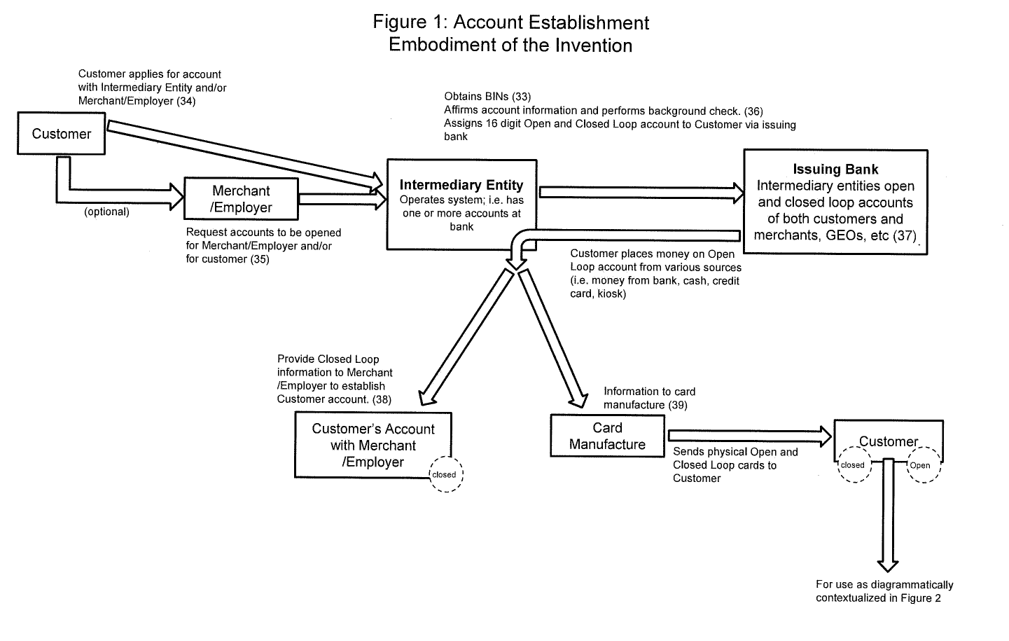

FIG. 1 depicts a general view of the major components of the unique intermediary or escrow-like accounts and their establishment in accordance with an embodiment of the present invention. An Intermediary Entity initially obtains a block of Bank Identification Numbers (“BIN numbers”) for use by ‘issuing banks’ on the Intermediary Entities' open and closed sub-accounts 33. [Note BINs are the first six (6) digits of the sixteen (16) digits on a credit/debit card.] The entity issues the BINs with the additional digits (most likely 10, with the initial 6 digits then has 16 digits total). This resultant BIN incorporates the various legal, banking industry, Merchant and/or GEO requirements (such as ISO-7812-1&2) for the particular Customer or account related card or payment product.

Customer requests enrollment in a sub-account program of the Intermediary 34. Doing so entails an application process which supplies all required information for the running by the Intermediary of the banking industry related checks on the applicant insuring compliance with what are commonly called the “know your customer” standards

Merchant, GEO, Employer, Gift Card Promoter, etc., requests of the Intermediary Entity that Customer's account be opened according to its standards, using its BINs 35.

On such request, the Intermediary Entity: a) confirms the information received and runs background on the applying customer (such lists or qualifiers as the know your customer regulations, the OFAC list, reviews of legal status of applicant including such matters as drug money, money laundering and other criminal convictions or algorithm detected suspicious behaviors) 36; and b) assigns the appropriate BIN 37.

Following the successful completion of the application and data base screening portion of the process, the Intermediary confirms such completed steps and requests of the Issuing Bank the opening of the sub-account (open and/or closed loop) for the complying Customer and transfers the opening deposit (if any; or the information to the Customer such that he/she may do the same) to such now authorized sub-account 37. Note that Intermediary may also have sub-accounts for the respective Merchant, GEO, Employer, or other user desirous of an account with such features and flexibilities that the invention embodies.

To the extent needed for sub-account maintenance, processing Intermediary supplies Merchant, GEO, Employer or other such account sponsor with the needed links for access to its Customer/employee's use of their respective connected sub-account 38.

Intermediary Entity then directs card manufacturer on customization of a card for qualifying Customer and directs their delivery to the Customer for use 39.

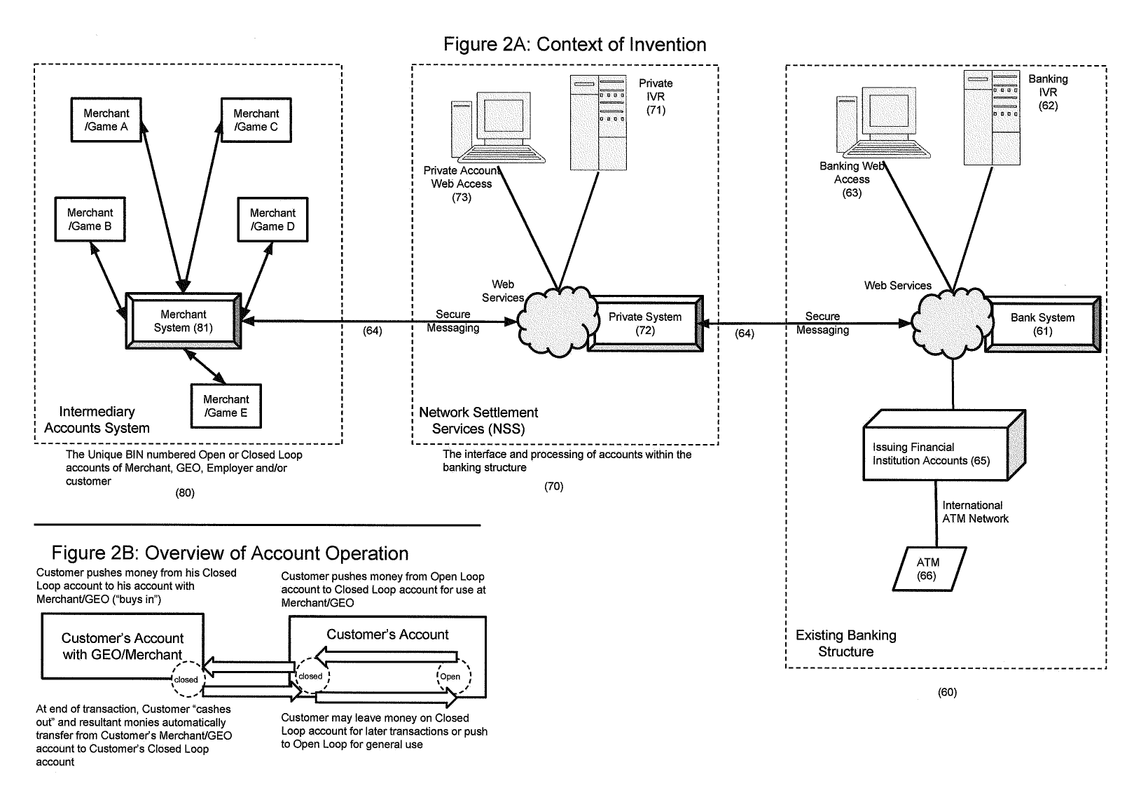

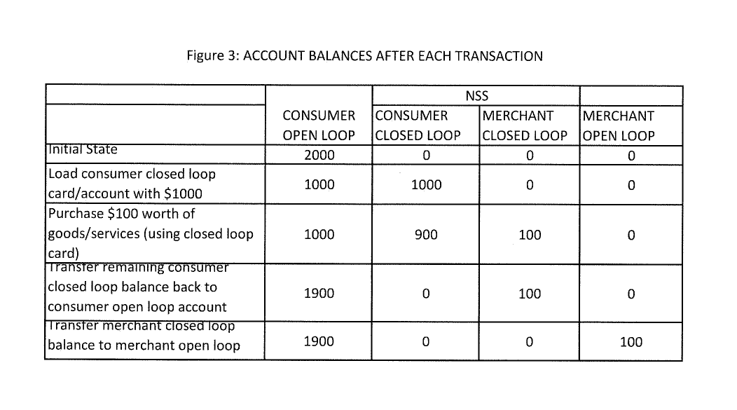

FIG. 2 depicts the context of the unique account structure from two contextual perspectives: A (the top most section) from the perspective of the entities or functions and their relationship in the global financial network; and B (the lower section) representing the context of a Customer's account with a Merchant, GEO, Employer, etc., as the case may be. FIGS. 3 & 4 then demonstrate what the Customer and Merchant's account balances look like in two different hypothetical, exemplary scenarios. First, then, at the high level, there is a conventional banking system 60, network settlement services (NSS), or interface 70, that acts as an intermediary payment system, and an intermediary accounts system 80. Network settlement services (NSS) 70 acts as a go-between between banking system 60 and merchant or gaming services 80 as will be explained in more detail below.

Banking system 60 includes computer systems or means for bank card processing 61. The bank card processing means 61 operates in accordance with well-known and conventional standards. For instance, a customer can use Interactive Voice Response (IVR) 62 or online banking services 63 via network 64 to effect account management and funds transfers. Bank card processing means 61 is also in communication with issuing financial institution accounts 65 which are themselves accessible by customers via, for example, automatic teller machines (ATMs) 66 over the existing international ATM network. The present invention does not modify presently-available services available through banking system 60, but, as will be better appreciated from the description below, leverages these well-known services to fund Intermediary Entity sub-accounts in a unique manner.

Merchant and GEOs 80 include a merchant system 81 and, in the case of a gaming implementation, a plurality of games A-E (which could also be point of sale terminals in the context of a conventional merchant). A customer generally has two options for making a purchase within a gaming or merchant environment. First, the Customer can use an open-loop card/account to receive goods, services or access to gaming. However, as noted previously, open-loop networks such as MasterCard and Visa, expressly limit the use of their cards in gaming establishments. Thus, at least in the context of gaming, the direct use of an open-loop card is often not possible. The second option for a Customer to obtain goods or services is to use a closed-loop card/account. A GEO is a classic example of where an electing Customer loads a card with a predetermined amount of money and then uses the card in, e.g., slot machines. (Merchants such as, e.g., Barnes & Noble, Nordstrom among others, have similar closed loop accounts that can be used at point of sale terminals and over the Internet.) This permits the Merchant or GEO to more easily track the usage of card-holding patrons and machines, and further eliminates the need to carry substantial amounts of cash or coins. The problem, as identified previously, is that it is difficult, especially in gaming environments, to transfer funds from an open-loop system such as one's credit card, check card, bank account, or the like to a closed-loop card like that provided by a gaming establishment.

To solve this problem, network settlement services (NSS) or interface 70 acts as an intermediary payment system between banking system 60 and Merchant or gaming services 80. More particularly, interface 70 establishes secure messaging between both bank card processing means 61 and merchant system 81. From banking systems' 60 perspective interface 70 preferably “looks like” a Consumer who is simply performing account to account transfers to a settlement account. That is, in accordance with the present invention, bank system 60 is employed to hold several accounts from and into which funds can be transferred. For instance, in the context of a gaming environment, a single bank within banking system 60 would hold open loop accounts for users/gamblers who also have corresponding closed loop accounts associated with, e.g., a casino. Network settlement services or Intermediary 70 would also hold an account with the same bank. Finally, the same bank would establish accounts for each of the Merchants, GEOs or games with which the closed loop accounts can be used. As such, all transactions with regard to loading a closed loop card/account from an open loop account, and using the closed loop card to, e.g., play slot machines, or buy chips, are performed by account-to-account transfers within the same bank. Thus, banking system 60 would ‘see’ account-to-account transfers from the settlement account to various merchant accounts, possibly in both directions, and at times ‘see’ the money being returned to the original Consumer's account from the settlement account. In each case, movement perceived by banking system 60 is accomplished as a series of account-to-account transfers using the settlement services (70) account as an intermediary. It is noted that the several open loop accounts described herein need not necessarily be at the same financial institution or bank, as long as appropriate account to account transfers within an open loop system can be performed among the several accounts.

From the perspective of Merchant or gaming services 80, interface 70 functions as a “closed” accounting system that is tied with merchant system 81.

In practice, a Customer, perhaps using a cell phone, contacts IVR 71 of network settlement services 70. IVR 71 will prompt the Customer for identification and password information, as necessary, and will allow the Customer to transfer funds from banking system 60 to closed accounting system 72 (which is really an open loop account operated or controlled by NSS 70). In so doing, and because closed accounting system 72 and merchant system 81 are closely tied, merchant system 81 recognizes that the funds transferred are designated for that Customer's closed-loop account that may be used at the Merchant or GEO 80. Once funded, the closed-loop card essentially acts as a debit card within the environs of gaming or merchant services 80. The card can be replenished with funds from banking system 60 in response to further instructions from the Customer, and the Customer can likewise return funds from the closed-loop system to his/her open-loop account, again using IVR 71 or online system 73. A Customer may also perform account transfers from a kiosk (not shown) that may include a computer system that provides worldwide web access, or that has ATM functionality. Also, although IVR 71 may be used in a typical implementation, wireless devices generally (including cell phones) may also be used to cause funds transfers using non-voice communication, i.e., pure data communication exchange. In a preferred implementation, the Customer is provided a confirmation message that funds have been successfully transferred. Such a confirmation message may be provided by a mobile phone SMS message, email, or any other convenient methodology.

Also, those skilled in the art will appreciate that the Consumer may cause multiple “closed” transactions to take place without having to request a corresponding number of funds transfers into the closed system. That is, there is not necessarily a one-to-one relationship between open loop transfers and closed loop transactions.

Communication between merchant system 81 and NSS 70 may be implemented using XML exchanges that are proprietary between these entities. Funds transfers may also be effected by ACH, although such transactions may take many hours or even an entire day to clear. Still another way to move funds is to employ the open loop credit/debit “rails.” Although practical, movement of funds in this manner would likely be subject to charge-backs and interchange fees (perhaps 2-4%), which the parties might not want to incur.

FIG. 3 is a table that shows a single Consumer open loop account, a single Merchant open loop account and a single network settlement service (NSS) open loop account that keeps track of respective closed loop accounts for the Consumer and Merchant. As is evident from FIG. 2, NSS 70 accounts for all closed loop transactions. As noted previously, even though closed loop transactions are occurring, the funds, from a bank's perspective, are all seen as being transferred among three different open loop accounts. NSS 70, however, operates as a proxy for the closed loop system, thus enabling significant control of funds by the Consumer, and “safety” of funds for the Merchant.

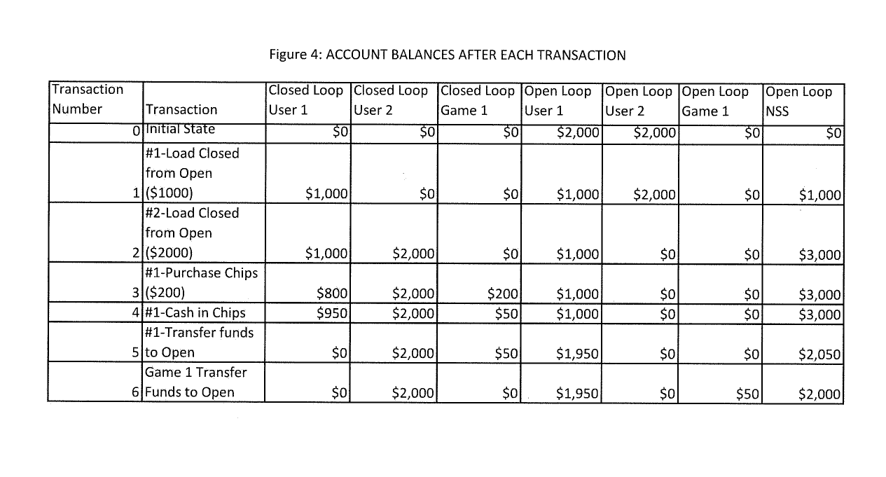

FIG. 4 is a table that shows, sequentially, a more complicated series of open and closed loop account balances for two users in accordance with the present invention. As will be appreciated by those skilled in the art, interface 70 can keep track of the transactions of multiple users or customers, consumers and games. The interface 70 itself appears as a single bank account from the perspective of banking system 60, but internally, identifies and designates the amount of funds for each of the users or customers and games.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For instance, the “accounts” described herein should be understood to also broadly include debit cards, checking cards (open-loop), and even closed-loop cards.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on any claims.

What is claimed is:

1. A method of operating an intermediary payment system, comprising: establishing at a financial institution an account controlled by an intermediary entity, the account being associated with an open loop financial system, the intermediary entity establishing closed loop financial system sub-accounts using unique BINs for each of a plurality of consumers and each of a plurality of merchants or devices that accept payment via the closed loop financial system; receiving at the intermediary entity a request from one of the consumers that results in funds being transferred to the account controlled by the intermediary entity, the intermediary entity crediting the funds to the closed loop financial system sub-account belonging to that consumer; receiving at the intermediary entity an indication from one of the merchants or devices that the one of the account-holding consumers made a purchase or wagered a given value of funds within the closed loop financial system; debiting the given value of funds from the closed loop financial system sub-account belonging to the initiating account-holding consumer and crediting the given value of funds to the closed loop financial system sub-account belonging to the electing merchants or gaming establishment; and transferring the given value of funds from the sub-account belonging to the electing merchant or devices to an open loop financial system account belonging to the merchant that operates the business, or GEO that provides access to the gaming.

2. The method of claim 1, wherein the request is initiated from a telephone.

3. The method of claim 1, wherein the consumer seeking to establish the sub-account does not have a bank account.

4. The method of claim 1, wherein the request is initiated via interne access.

5. The method of claim 1, further comprising communicating with the one of the consumers via an interactive voice response (IVR) system that is associated with the intermediary payment system

6. The method of claim 1, wherein the request is initiated via a form of communication.

7. The method of claim 1, further comprising establishing secure communications between the electing consumer, the financial institution and the intermediary entity, and between the intermediary entity and one of the merchants or devices, and the consumer's account.

8. The method of claim 1, wherein the one of the gaming devices is a slot or video poker machine.

9. The method of claim 1, wherein the indication is initiated by the use of a closed loop card.

10. The method of claim 1, wherein a single given sub-account is associated with a plurality of the gaming devices.

11. The method of claim 1, wherein the intermediary oversees the banking compliance qualification of the consumer applying for an account.

12. The method of claim 1, wherein the intermediary oversees the establishment of rules for a plurality of different categories of sub-accounts.

13. The method of claim 1, wherein the processing of the sub-account transaction via the established banking networks attributes the account activity to the intermediary instead of the sub-account consumer.

14. A method of transferring funds between an open loop financial system and a closed loop financial system of a merchant or a gaming establishment, comprising: issuing an open loop card, bearing the intermediary entity's uniquely assigned BIN, and a merchant or gaming establishment's related closed loop card, bearing the intermediary entity's uniquely assigned, different BIN, to an electing consumer, the open loop card being associated with an open loop account, and the merchant or gaming establishment related closed loop card being associated with a merchant or gaming establishment related closed loop account that can be used to make purchases only with that merchant or to wager money within such gaming establishment; receiving a request from the consumer, initiated from a communications device, to transfer a selected amount of money from the open loop account to the merchant or gaming establishment related closed loop account; transferring the selected amount of money from the open loop account to the merchant or gaming establishment related closed loop account; receiving a notification that the electing consumer made a purchase or wagered an amount of money at the selected merchant or device associated with the gaming establishment; debiting the merchant or gaming establishment related closed loop account by an amount equivalent to the value of the purchase of goods or services or the money wagered; and crediting a merchant or gaming establishment related closed loop account by the amount equivalent to the value of the purchase or the money wagered, wherein the merchant or gaming establishment related closed loop account are provided for by an intermediary payment system that has an associated open loop account and that operates the merchant or gaming establishment related closed loop account as sub-accounts of the associated open loop account.

15. A method of operating an intermediary payment system, comprising: establishing at a financial institution an account controlled by an intermediary entity, the account being associated with an open loop financial system, bearing the intermediary entity's uniquely assigned BIN, the intermediary entity establishing closed loop financial system sub-accounts, bearing the intermediary entity's uniquely assigned, different BIN, for each of a plurality of electing consumers and each of a plurality of transactional entities that accept payment via the closed loop financial system; receiving at the intermediary entity a request from one of the account-holding consumers that results in funds being transferred from the electing account-holding consumer to the account controlled by the intermediary entity, the intermediary entity crediting the funds to the closed loop financial system sub-account belonging to the account-holding consumer; receiving at the intermediary entity an indication from one of the transactional entities that one of the consumers purchased a given value of goods or services within the closed loop financial system; debiting the given value from the closed loop financial system sub-account belonging to that electing consumer and crediting the given value to the closed loop financial system sub-account belonging to the supplying account-holding transactional entity; and transferring the given value from the sub-account belonging to the electing transactional entity to an open loop financial system account belonging to one of the directed transactional entities.

16. The method of claim 15, wherein the request is initiated from a telephone.

17. The method of claim 15, wherein the request is initiated via interne access.

18. The method of claim 15, wherein the request is initiated via a form of communication.

19. The method of claim 15, further comprising communicating with the consumer via an interactive voice response (IVR) system that is associated with the intermediary payment system.

20. The method of claim 15, further comprising establishing secure communications between the consumer account-holder financial institution and the intermediary entity, and between the intermediary entity, the transactional entities and the consumer account-holder.

21. The method of claim 15, wherein the transaction indication is initiated by the use of a closed loop card.

22. The method of claim 15, wherein a single given sub-account is associated with a plurality of transactional entities.

23. A method of transferring funds between an open loop financial system and a closed loop financial system, comprising: issuing an open loop card, bearing the intermediary entity's uniquely assigned, different BIN, and a closed loop card, bearing the intermediary entity's uniquely assigned, different BIN, to a consumer, the open loop card being associated with an open loop account and the closed loop card being associated with a closed loop account that can be used to purchase goods or services from a selected provider of the goods and services; receiving a request from the account-holding consumer, initiated from a communication device, to transfer a selected amount of money from the open loop account to the closed loop account; transferring the selected amount of money from the open loop account to the closed loop account; receiving a notification that the consumer used the closed loop card to purchase goods or services for a particular value of money; debiting the closed loop account by an amount equivalent to the value of money paid for the goods or services; and crediting a closed loop account of the selected provider of the goods or services by an amount equivalent to the value of money, wherein the closed loop accounts are provided for by an intermediary payment system that has an associated open loop account and that operates the closed loop accounts as sub-accounts of the associated open loop account.
